(19) United States
(12) Patent Application Publication
(10) Pub. No.: US 2014/0114872 A1
(43) Pub. Date: Apr. 24, 2014

(54) SYSTEM AND METHOD FOR MANAGING VOLUNTARY EMPLOYEE BENEFIT PLANS

(71) Applicant: HARTFORD FIRE INSURANCE COMPANY, Hartford, CT (US)

(72) Inventors: David Conn Morgan, Collinsville, CT (US); Andrea L. Savastra, Newington, CT (US); Wendy A. Wojdyl, West Hartford, CT (US)

(73) Assignee: HARTFORD FIRE INSURANCE COMPANY, Hartford, CT (US)

(21) Appl. No.: 13/654,979

(22) Filed: Oct. 18, 2012

(51) Int. Cl. G06Q 10/06

(52) U.S. Cl. 705/322

(57) ABSTRACT

According to some embodiments, a system may receive, from an employee, a request to access a voluntary employee benefit portal. The system may determine an employer associated with the employee and access information about a set of voluntary employee benefit plans associated with determined employer. Information associated with the voluntary employee benefit portal may then be transmitted, and the transmitted information may be customized based at least in part on the information about the set of voluntary employee benefit plans associated with the determined employer.

### BACKGROUND

An employer may arrange with an insurance provider to offer voluntary benefit plans to employees. For example, the employer and insurance provider may offer short and long term disability insurance plans, life insurance plans, etc. to employees who wish to purchase them. Note that different employers may offer different types and/or combinations of plans. Moreover, some of the plans may differ depending on the employer (e.g., based on how many employees work for the employer) and/or may include various options that can be selected by employees (e.g., an amount of a life insurance benefit). As a result, it can be difficult to provide accurate information about benefit plans to employees—especially when a substantial number of employers and benefit plans involved. For example, difficult to facilitate access to information about various combinations of voluntary employee benefit plans, such as premiums and benefits associated with each plan. In some cases, employees may misunderstand the voluntary benefit plans and/or avoid purchasing them altogether.

It would therefore be desirable to provide systems and methods to efficiently and accurately facilitate access to information about voluntary employee benefit plans.

### SUMMARY OF THE INVENTION

According to some embodiments, systems, methods, apparatus, computer program code and means may be provided to efficiently and accurately facilitate access to information about voluntary employee benefit plans. In some embodiments, a system may receive, from an employee, a request to access a voluntary employee benefit portal. The system may determine an employer associated with the employee and access information about a set of voluntary employee benefit plans associated with determined employer. Information associated with the voluntary employee benefit portal may then be transmitted, and the transmitted information may be customized based at least in part on the information about the set of voluntary employee benefit plans associated with the determined employer.

Some embodiments comprise: means for receiving, from a remote employee device via a communication network, a request to access a voluntary employee benefit portal; means for automatically determining, buy a portal management platform, an employer associated with the employee; means for automatically accessing information about the set of voluntary employee benefit plans associated with determined employer; means for assigning the employee into a category; and means for transmitting, to the remote employee device, information associated with the voluntary employee benefit portal, wherein the transmitted information is customized based at least in part on the assigned category and the information about the set of voluntary employee benefit plans associated with the determined employer.

A technical effect of some embodiments of the invention is may be an improved and computerized method of providing access to information about voluntary employee benefit plans. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a system according to some embodiments of the present invention.

FIG. 2 illustrates a method according to some embodiments of the present invention.

FIGS. 3 through 7 illustrate voluntary employee benefit portal displays according to some embodiments.

FIG. 8 is an information flow diagram associated with a loyalty program in accordance with some embodiments.

FIG. 9 is an example of a voluntary employee benefit portal display for a PC web browser in accordance with some embodiments.

FIG. 10 illustrates an employer portal development display in accordance with some embodiments.

FIG. 11 is an example of an enrollment application display for a mobile device in accordance with some embodiments.

FIG. 12 is an example of a voluntary employee benefit portal platform according to some embodiments.

FIG. 13 is a tabular portion of a voluntary employee benefit portal database according to some embodiments.

FIG. 14 is block diagram of a system data flow according to some embodiments of the present invention.

### DETAILED DESCRIPTION

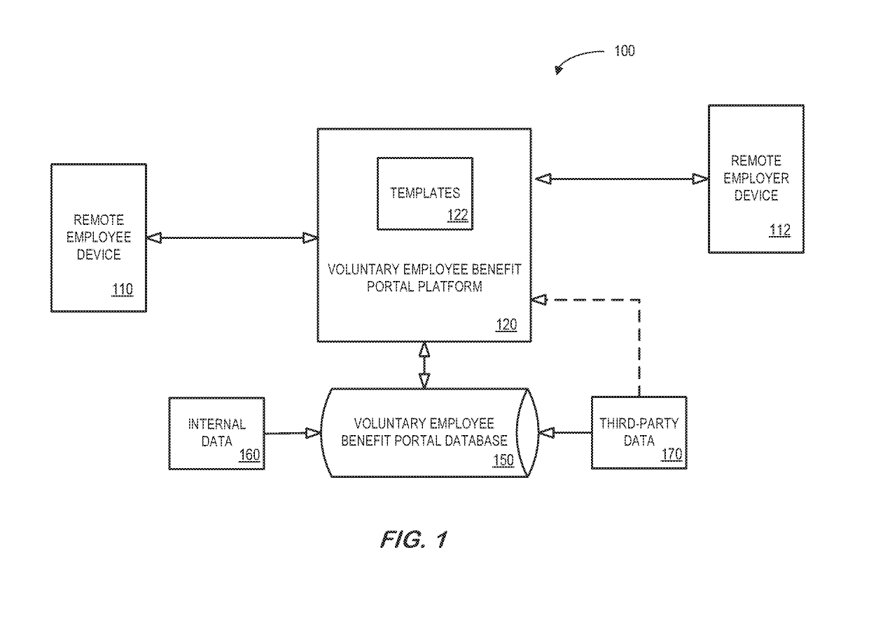

FIG. 1 is block diagram of a system 100 according to some embodiments of the present invention. In particular, a remote employee device 110 may transmit a request for information about benefit plans to a voluntary employee benefit portal platform 120. According to some embodiments, multiple remote employee devices 110 may submit such requests to the benefit portal platform 120 via a web browser and/or a plug-in for a web browser. According to some embodiments, the benefit portal platform also exchanges information with one or more remote employer devices 112. Note that some or all of the functions described with respect the voluntary employee benefit portal platform 120 might be performed by an employer device or an insurance provider device. The remote employee devices 110 might comprise, for example, Personal Computers (PCs), laptop or tablet computers, and/or wireless telephones, such as smartphones, that can transmit data to and/or receive data from the voluntary employee benefit portal platform 120.

According to some embodiments, the “automated” voluntary employee benefit portal platform 120 may help an employee explore and/or purchase voluntary benefit plans. As used herein, the term “automated” may refer to, for example, actions that can be performed with little or no human intervention. By way of example only, the voluntary employee benefit portal platform 120 may be associated with and/or communicate with a PC, an enterprise server, or a database farm. Moreover, according to some embodiments, templates 122 (e.g., including display preferences and graphical layout options) at the platform 120 may facilitate access to benefit plan information.

As used herein, devices, including those associated with the voluntary employee benefit portal platform 120, and any other device described herein may exchange information via any communication network (not illustrated in FIG. 1) which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Although a single voluntary employee benefit portal platform 120 is shown in FIG. 1, any number of such devices may be included. Moreover, various devices described herein might be combined according to embodiments of the present invention. For example, in some embodiments, the voluntary employee benefit portal platform 120 and a voluntary employee benefit portal database 150 might be co-located and/or may comprise a single apparatus. Moreover, according to some embodiments, internal data 160 (e.g., data about benefit plans offered to various employers) and/or third-party data 170 (e.g., credit score or similar information) may be used to supplement the information in the voluntary employee benefit portal database 150. Note that the internal data 160 and/or third-party data 170 might also be provided directly to the platform 120 (e.g., as illustrated by the dashed arrow in FIG. 1).

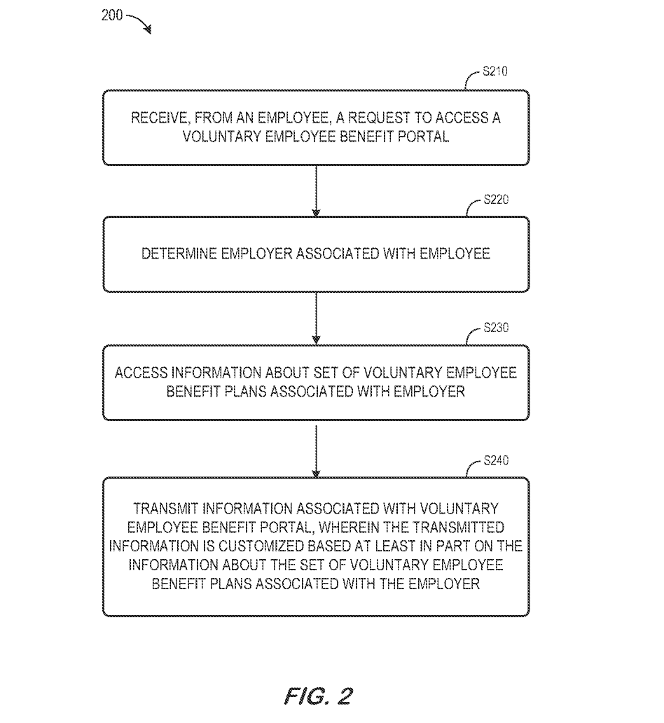

The system 100 of FIG. 1 may be used to help a person explore various benefit plans and options in a way that is simple to understand. For example, FIG. 2 illustrates a process 200 that might be performed, for example, by some or all of the elements of the system 100 described with respect to FIG. 1 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

The process 200 may be performed to facilitate a person's understanding of employee benefit plans. Pursuant to some embodiments, at S210 a system may receive, from an employee, a request to access a voluntary employee benefit portal. Note that the process 200 may support various employers, each employer being associated with a set of employees who work for that employer and/or a set of benefit plans that are offered to those employees. Moreover, the voluntary employee benefit plans might be associated with, for example, term life insurance, short term disability insurance, long term disability insurance, critical illness insurance, accident insurance, dental insurance, vision care insurance, flexible disability insurance (e.g., a simplified user-definable combination of short and long term disability insurance plans), and/or a package of insurance options.

At S220, the system may determine an employer associated with the employee. For example, the system might determine that person requesting access to the portal works for “Company, Inc.” Note that the determination of the employer might be based on, for example, an employer identifier (e.g., a company name) or an employee identifier (e.g., an employee's name or badge number). Moreover, this information might be provided by the employee (e.g., he or she might enter his or her name into a web browser field) and/or provided by the employer (e.g., the employer might provide a list of employee badge numbers).

At S230, the system may access information about the set of voluntary employee benefit plans associated with determined employer. For example, it might be determined that the particular employer associated with the employee accessing the portal offers short and long term disability plans but not a life information plan.

At S240, the system may transmit information associated with the voluntary employee benefit portal, and the transmitted information may be customized based at least in part on the information about the set of voluntary employee benefit plans associated with the determined employer. Note that the customization might be performed by an insurance provider or a third party administrator associated with the benefit plans.

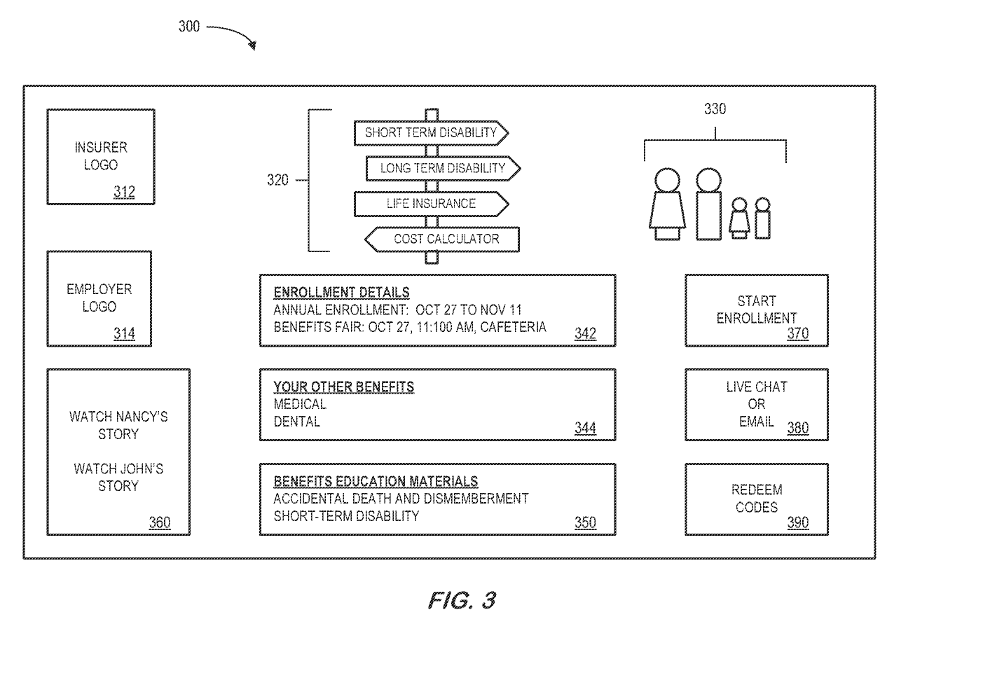

The transmitted information might include, for example, available plan options and/or insurance rates. According to some embodiments, the voluntary employee benefit portal system may interact with an employee via an easy to understand Graphical Employee Interface (“GUI”). For example, FIG. 3 illustrates a voluntary employee benefit portal display 300 according to some embodiments. The display 300 might be customized, for example, by displaying an appropriate insurer logo 312 and/or employer logo 314. Similarly, the display 300 might include an employer name, display preferences (colors and layouts based on a template selected by the employer or insurance provider), available plan navigation options 320, employee family information 330, plan enrollment 342 and benefit 344 information, educational materials (e.g., videos or documents explaining various plans), marketing and/or testimonial information 360 (e.g., appropriate testimonial videos might be selected based at least in part on information about the employee), an ability to begin an enrollment process 370, contact and/or live contact support information 380, enrollment period information, scheduled events (e.g., the time and date of a benefits fair), and question and answer information, such as link associated with a Frequently Asked Question (“FAQ”) web page for each available benefit plan. Referring to the example of FIG. 3, if it had instead been determined that the employee was associated with a different employer that did not offer a long term disability plan to employees, the second sign in the signpost option 320 might be automatically removed from the display 300.

The transmitted information used to generate the display 300 may, in some embodiments, be customized based on information about the employer. For example, the information about the employer might include a number of employees, a location, and/or a type of work performed (e.g., which might alter the premiums that presented on the display 300).

The transmitted information used to generate the display 300 may, in some embodiments, be customized based on information about the employee. For example, the information about the employee might include age, sex, occupation, address, marital status, and/or a number of children (e.g., which might alter the premiums that presented on the display 300). According to some embodiments, such information may be used to assign the employee into a category, and the transmitted information is further customized based on the assigned category. For example, younger, higher-risk males might see a different display 300 as compared to other employees. According to some embodiments, the transmitted information used to generate the display 300 is further customized based on information received from a third party service, for example, social media network data, a credit score, an age, a sex, an occupation, and/or an address from a third party service might be used to customize the display 300 for that particular employee.

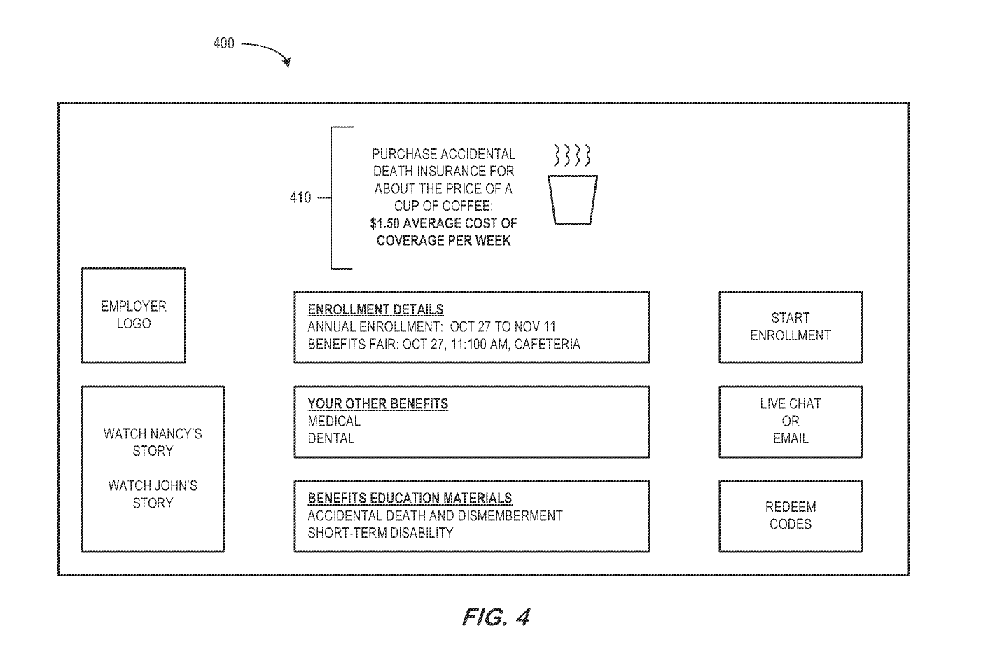

According to some embodiments, the transmitted information that is used generate the display 300 facilitates a display of benefit rate information to the employee, such as a predicted benefit rate or an actual benefit rate. Moreover, in some embodiments, the system may automatically translate benefit rate information into an equivalent consumer product or service. For example, FIG. 4 illustrates a voluntary employee benefit portal display 400 according to some embodiments. In particular, the display 400 includes a comparison 410 wherein a $1.50 average weekly cost of an insurance plan is translated into “about the cup of a price of coffee.” Note that the equivalent consumer product or service might be selected based at least in part on information about the employee (e.g., younger employees might see a different product comparison as compared to older employees).

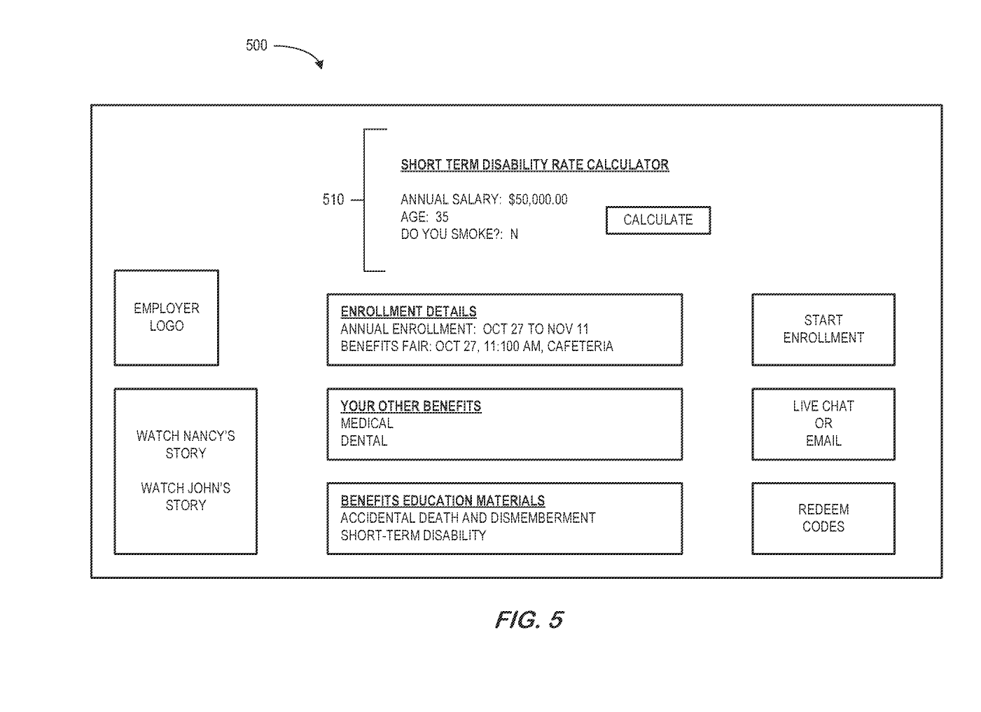

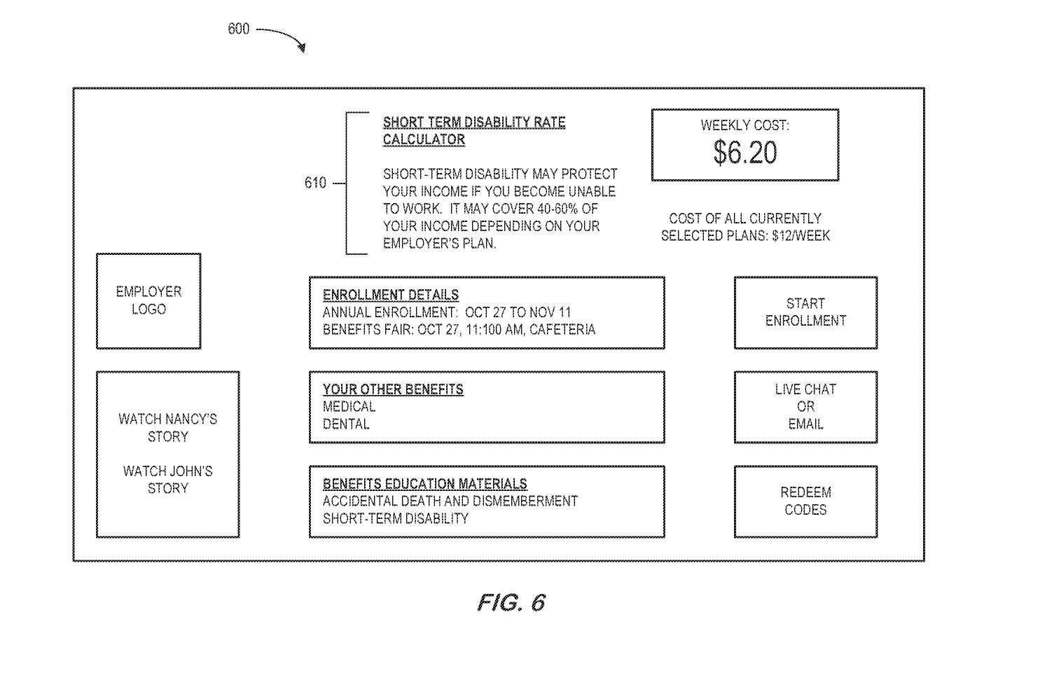

Referring again to FIG. 3, the display 300 may include navigation options 320, including a benefit plan “cost calculator.” An employee might use such a cost calculator, for example, to input information that might alter the price of a benefit plan. For example, FIG. 5 illustrates a voluntary employee benefit portal display 500 according to some embodiments. In particular, the display 500 includes a short term disability input area 510 can be used to enter an annual salary, age, and an indication of whether or not the employee smokes cigarettes. When the employee selects the “Calculate” icon, the system may automatically determine a premium value (predicted or actual) and display that value to the employee. For example, FIG. 6 illustrates a voluntary employee benefit portal display 600 including an output area 610 displaying a weekly cost along with the cost of all currently selected benefit plans according to some embodiments. Although a short term disability insurance calculator is illustrated in FIGS. 5 and 6, note that embodiments may be associated any other types of insurance plans, including, for example, long term disability insurance, life insurance, etc.

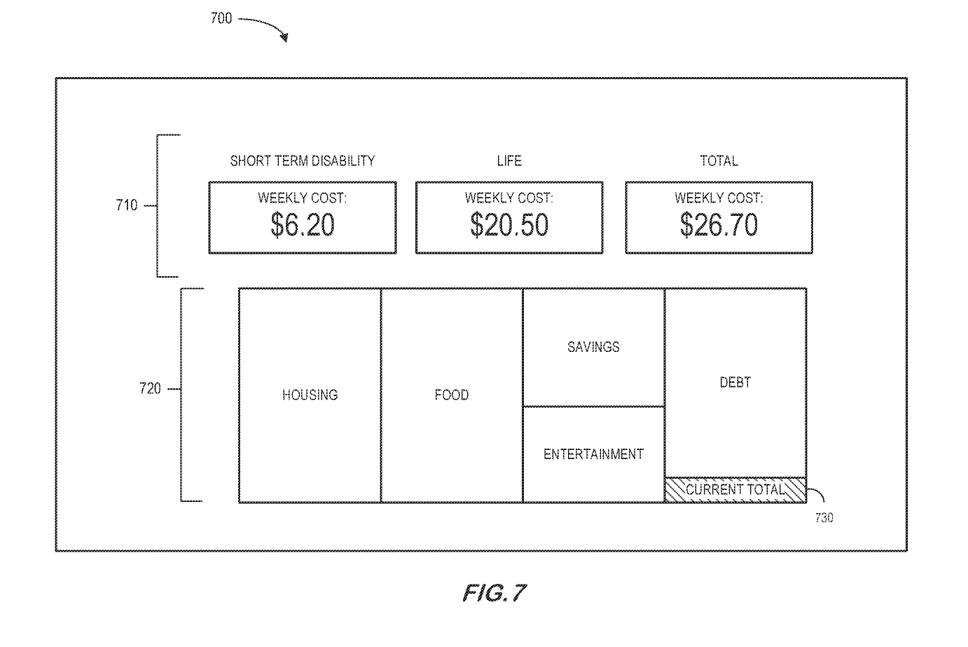

In can be difficult for an employee to weight the particular cost of a benefit plan. To help him or her do so, according to some embodiments benefit rate information may be graphically displayed as compared to other costs associated with the employee. For example, FIG. 7 illustrates a voluntary employee benefit portal display 700 showing the various plan premiums 710 along with a graphical comparison 720 comparing all of the employee's weekly costs with the total premium 720 of his or her currently selected benefit plans according to some embodiments. The comparison 720 might be based on actual values received from the employee or typical values for other people (e.g., of the same age).

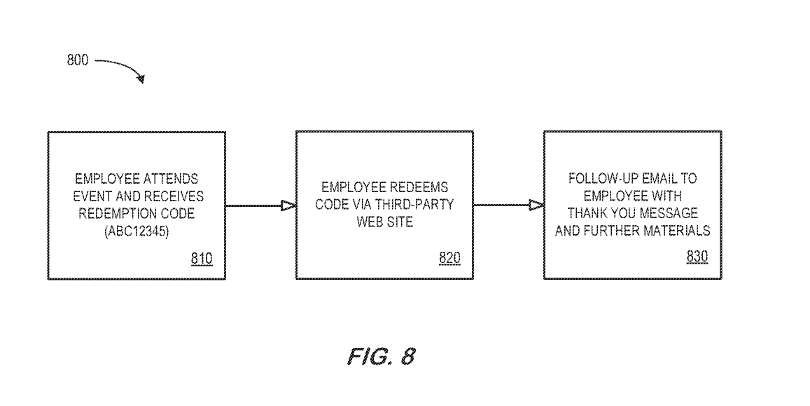

Referring again to FIG. 3, according to some embodiments the display 300 may support a loyalty program in which an employee may receive and/or redeem codes 390 to encourage participation in the benefit plans. For example, FIG. 8 illustrates a voluntary employee benefit portal loyalty program 800 according to some embodiments. In this example, the employee might attend an event, such as a benefits fair, and receive a redemption code 810 (e.g., either electronically or on a printed card). The employee may then redeem the code 820 via a third party web sight. For example, the employee might receive a free song, a social network game, etc. as a reward for attending the benefit fair. A follow-up email might then be automatically transmitted to the employee 830 with a thank you message and/or further materials (e.g., educational and/or marketing materials).

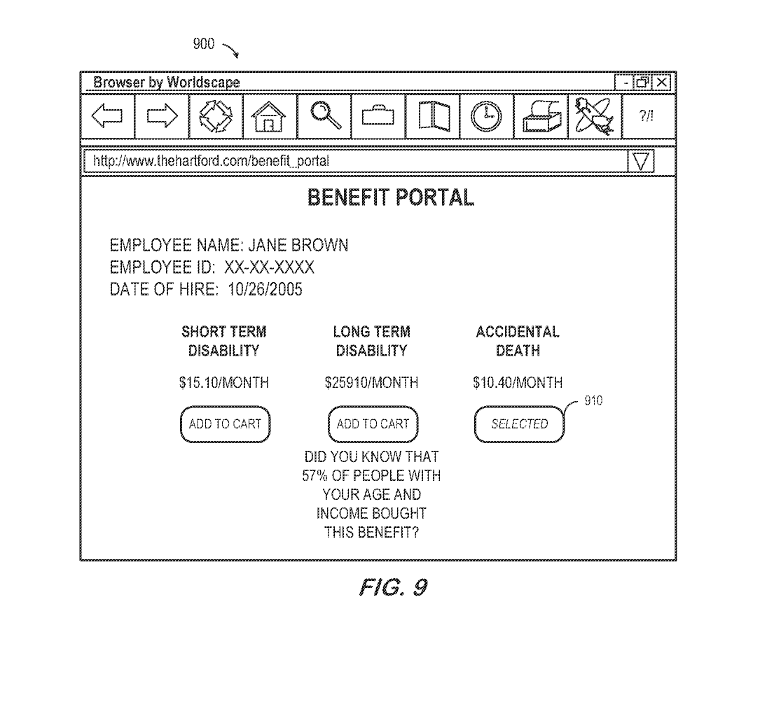

Referring again to FIG. 3, according to some embodiments the display 300 may support an employee's ability to begin an enrollment process 370. That is, the employee might begin a process of enrolling in a selected voluntary employee benefit plan (e.g., the system might automatically populate fields in one or more enrollment forms). For example, FIG. 9 illustrates a voluntary employee benefit portal display 900 according to some embodiments. In this example, the display 900 may let an employee select 910 various benefit plans to be placed into an “electronic shopping cart” to begin the enrollment process. According to some embodiments, the display might include customized marketing messages based on information about the employee and/or employer (e.g., indicating how many people with a similar age and income purchased a particular benefit plan).

Although particular features of the various portal displays provided herein have been described, note that embodiments might support other features instead of, or in additional to those described. For example, a portal display might support access, by the employee, to information about an insurance claim made in connection with at least one voluntary employee benefit plan. Similarly, a benefit plan portal display might support a rating and/or review employee application (e.g., an employee might rate a particular benefit plan as deserving four out of a possible five stars).

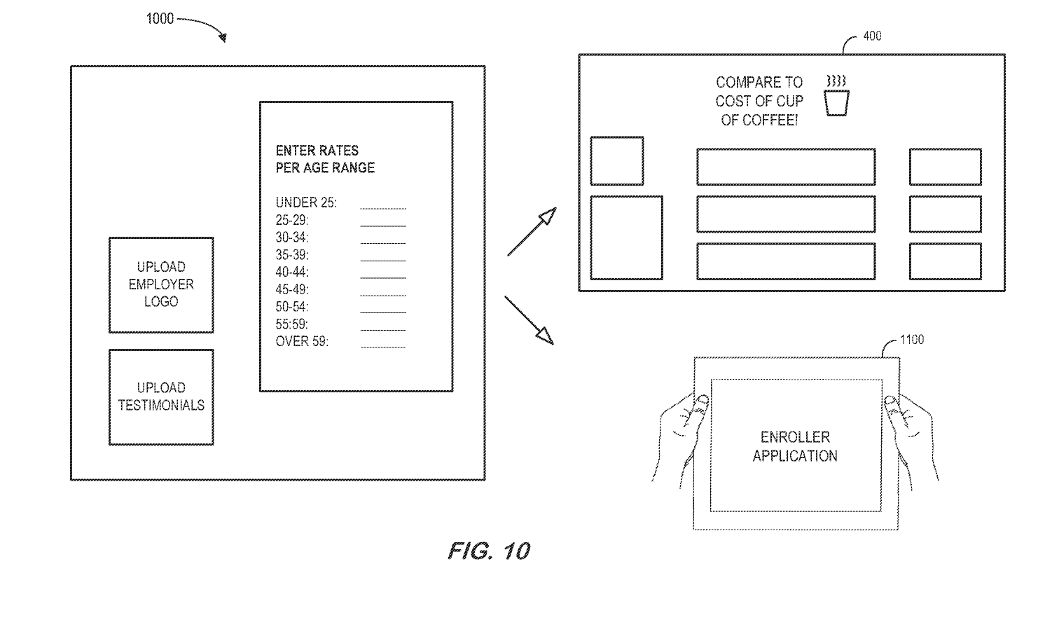

According to some embodiments, an insurance provider or third party administrator may help create a benefit plan portal for various employers. For example, FIG. 10 illustrates an employer portal development display 1000 in accordance with some embodiments. An insurance provider might use the development display 1000, for example, to upload an employer logo and/or testimonials that may be shown in a benefit plan portal for that particular employer. Similarly, insurance premium rates might be entered for various age ranges (e.g., a rate might be entered to be offered to employees between the ages of 25 and 29 years old). The information entered via the development display 1000 may then be automatically used to create the voluntary employee benefit portal display 400 that will be shown the employees of that particular employer.

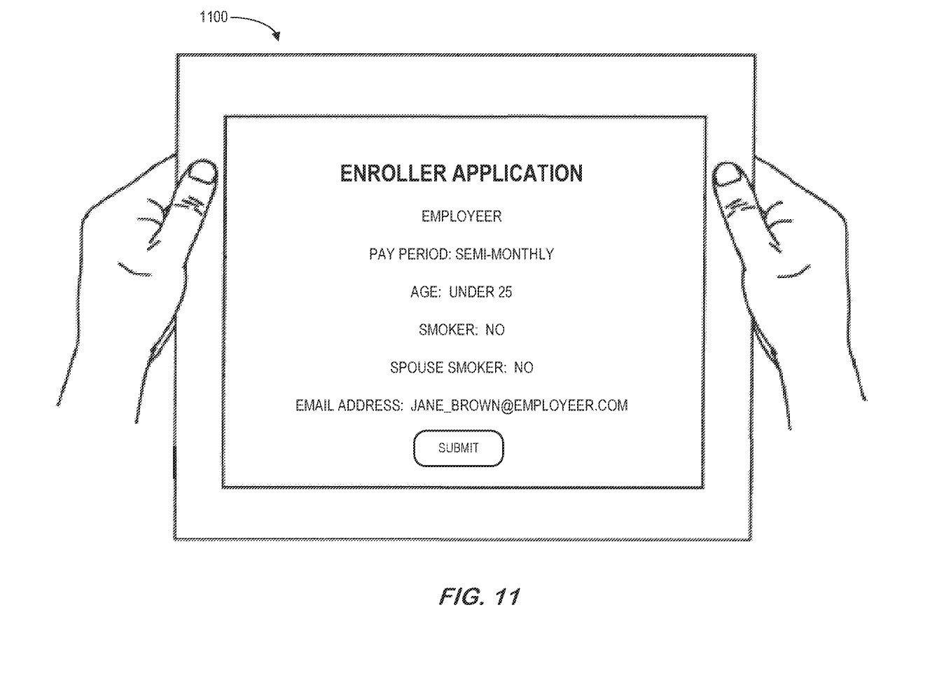

According to some embodiments, the information entered via the development display 1000 may also be automatically used for an enroller application 1100 that may be used, for example, at a benefits fair for employees of that particular employer. For example, FIG. 11 illustrates such an enroller application 1100 according to some embodiments. In particular, the enroller application 1100 might display an employer name and be used to enter an employee's par period, age, smoking status, etc. A “Submit” icon may then be used to provide the information to an insurance provider and to receive a predicted or actual premium value for that employee.

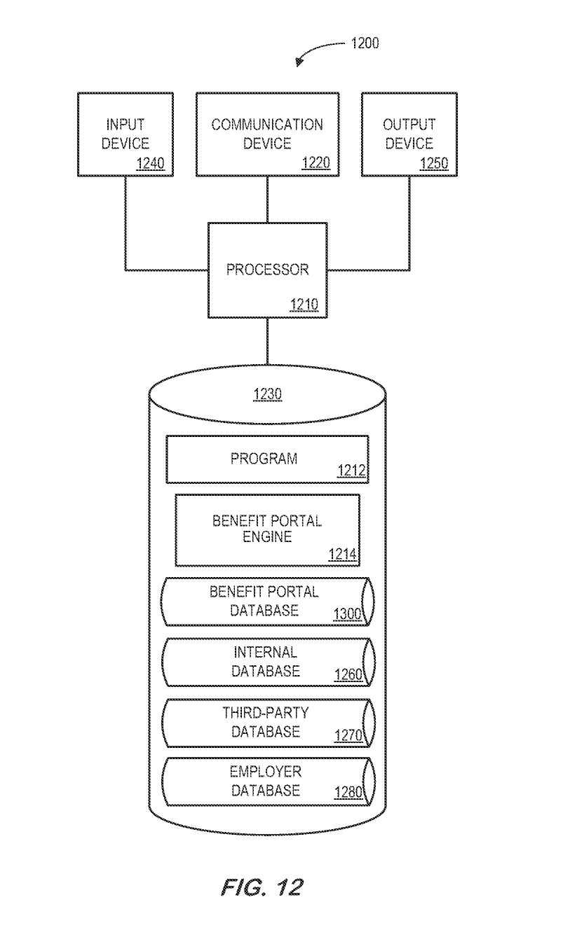

Note that embodiments described herein may be implemented in any number of different ways. For example, FIG. 12 is a block diagram overview of a voluntary employee benefit portal platform 1200 according to some embodiments. The voluntary employee benefit portal platform 1200 may be, for example, associated with the system 100 of FIG. 1. The voluntary employee benefit portal platform 1200 comprises a processor 1210, such as one or more commercially available Central Processing Units (CPUs) in the form of one-chip microprocessors, coupled to a communication device 1220 configured to communicate via a communication network (not shown in FIG. 12). The communication device 1220 may be used to communicate, for example, with one or more remote employee devices. The voluntary employee benefit portal platform 1200 further includes an input device 1240 (e.g., a mouse and/or keyboard to enter benefit plan information) and an output device 1250 (e.g., a computer monitor to display reports and/or aggregated results to an administrator).

The processor 1210 also communicates with a storage device 1230. The storage device 1230 may comprise any appropriate information storage device, including combinations of magnetic storage devices (e.g., a hard disk drive), optical storage devices, mobile telephones, vehicle computers, and/or semiconductor memory devices. The storage device 1230 stores a program 1212 and/or voluntary employee benefit portal engine 1214 for controlling the processor 1210. The processor 1210 performs instructions of the programs 1212, 1214, and thereby operates in accordance with any of the embodiments described herein. For example, the processor 1210 may receive, from an employee, a request to access a voluntary employee benefit portal. The processor 1210 may determine an employer associated with the employee and access information about a set of voluntary employee benefit plans associated with determined employer. Information associated with the voluntary employee benefit portal may then be transmitted by the processor 1210, and the transmitted information may be customized based at least in part on the information about the set of voluntary employee benefit plans associated with the determined employer.

The programs 1212, 1214 may be stored in a compressed, uncompiled and/or encrypted format. The programs 1212, 1214 may furthermore include other program elements, such as an operating system, a database management system, and/or device drivers used by the processor 1210 to interface with peripheral devices.

As used herein, information may be “received” by or “transmitted” to, for example: (i) the voluntary employee benefit portal platform 1200 from another device; or (ii) a software application or module within the voluntary employee benefit portal platform 1200 from another software application, module, or any other source.

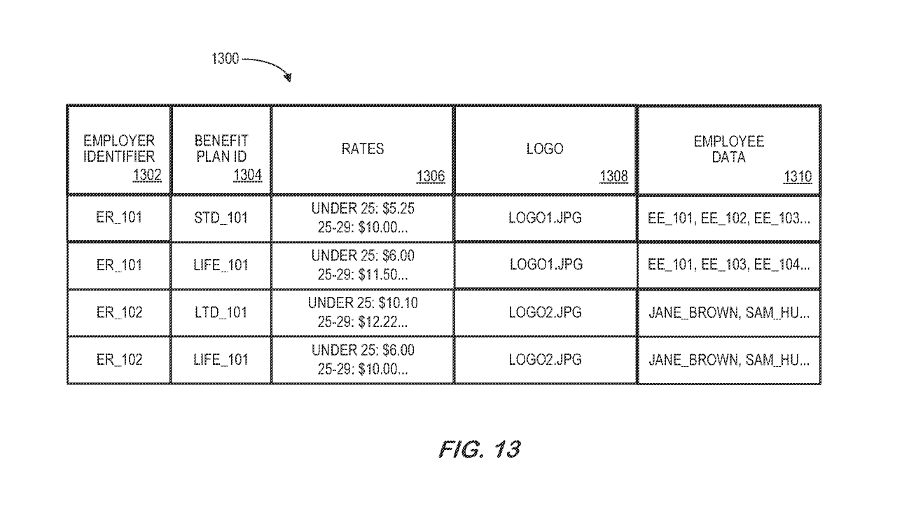

In some embodiments (such as shown in FIG. 12), the storage device 1230 stores a voluntary employee benefit portal database 1300 (described with respect to FIG. 13), an internal database 1260 (e.g., storing account information associated with various employers), and a third-party database 1270 (e.g., storing credit scores or other information that may be used in connection with voluntary employee benefit portal calculations). According to some embodiments, the storage device 1230 further stores a report database includes summary reports that have been generated for employers. Note that the databases described herein are examples, and additional and/or different information may be stored therein. Moreover, various databases might be split or combined in accordance with any of the embodiments described herein.

Referring to FIG. 13, a table is shown that represents the voluntary employee benefit portal database 1300 that may be stored at the voluntary employee benefit portal platform 1200 according to some embodiments. The table may include, for example, entries identifying employers associated with the voluntary employee benefit portal platform 1200. The table may also define fields 1302, 1304, 1306, 1308, 1310 for each of the entries. The fields 1302, 1304, 1306, 1308, 1310 may, according to some embodiments, specify: an employer identifier 1302, a benefit plan identifier 1304, rates 1306, logos 1308, and employee data 1310. The information in the voluntary employee benefit portal database 1300 may be created and updated, for example, whenever employers update benefit plans that are offered to employees.

The employer identifier 1302 may be, for example, a unique alphanumeric code identifying a company who arranges with an insurance provider to offer benefit plans to employees. The benefit plan identifier 1304 may indicate which plans are being offered (e.g., short or long term disability, etc.). The rates. 1306 may reflect the premiums for each plan (by age range) and the logos 1308 might comprise image information that should be used to construct the benefit portal that will be displayed in connection that employer. The employee data 1310 might comprise, for example, employee codes or name that may be used to identify and/or authenticate people attempting to access the benefit plan portal.

Although specific examples of information that might be stored in a voluntary employee benefit portal system have been described herein (e.g., in connection with the voluntary employee benefit portal database 1300, the internal database 1260, and/or the third party database 1270), note that many other types of information might be used in addition to, or instead of, the examples provided. For example, an employee password associated with a social media web site might also be stored.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

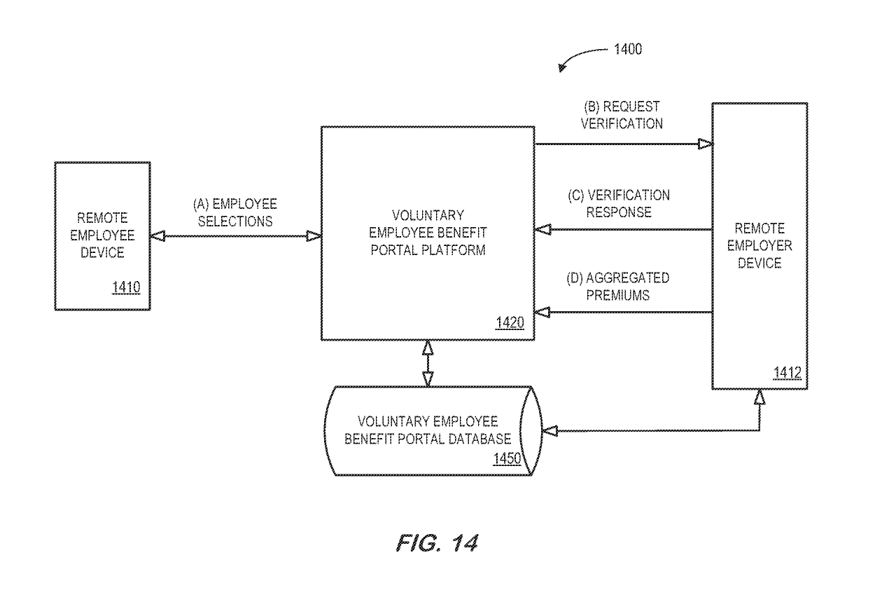

Although specific hardware and data configurations have been described herein, note that any number of other configurations may be provided in accordance with embodiments of the present invention (e.g., some of the information associated with the databases described herein may be combined or stored in external systems). Moreover, in accordance with embodiments described herein various platforms may exchange data in different ways. For example, FIG. 14 is block diagram of a system data flow 1400 according to some embodiments of the present invention. In particular, a remote employee device 1410 may select to purchase various combinations of voluntary insurance benefit plans be exchanging information at (A) with a voluntary employee benefit portal platform 1420. According to some embodiments, multiple remote employee devices 1410 may submit such requests to the benefit portal platform 1420 via a web browser and/or a plug-in for a web browser.

According to some embodiments, the benefit portal platform also exchanges information with one or more remote employer devices 1412. For example, at (B) the benefit portal platform 1420 might transmit a verification request to the remote employer device 1412 to determine whether or not a particular employee is, in fact, eligible to purchase a long term disability insurance plan. Note that some or all of the functions described herein with respect the voluntary employee benefit portal platform 1420 might be performed by an employer device, a third party administrator system, or an insurance provider device. The remote employer device 1412 may then respond to the request at (C), such as by indicating that the employee is qualified to purchase the plans he or she had selected at (A). The remote employer device 1412 may also arrange for the appropriate premiums to be deducted from the employee's paycheck and transmit aggregated premiums to the benefit portal platform 1420 (or another device associated with the insurance provider) at (D) on a periodic bases (e.g., on a quarterly basis). Note that the aggregated premiums provided at (D) might be associated with a plurality of selected voluntary employee insurance plans as well as a plurality of employees.

Applicants have discovered that embodiments described herein may be particularly useful in connection with voluntary employee benefit portal. Note, however, that other types of financial planning and related products may also benefit from the invention. For example, embodiments of the present invention may be used to in connection with retirement plans and other types of information.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system associated with a plurality of employers, each employer being associated with a set of voluntary employee benefit plans, comprising:
a data storage device for storing data associated with the sets of voluntary employee benefit plans;
a computer processor for executing program instructions and for retrieving said data associated with the sets of voluntary employee benefit plans from the data storage device; and
a memory, coupled to the computer processor, for storing program instructions for execution by the computer processor to:
receive, from an employee, a request to access a voluntary employee benefit portal,
determine an employer associated with the employee,
access information about the set of voluntary employee benefit plans associated with determined employer, and
transmit information associated with the voluntary employee benefit portal, wherein the transmitted information is customized based at least in part on the information about the set of voluntary employee benefit plans associated with the determined employer.

2. The system of claim 1, wherein the determination of the employer is based on at least one of an employer identifier, an employee identifier, information provided by the employee, and information provided by the employer.

3. The system of claim 1, wherein at least one voluntary employee benefit plan is associated with at least one of term life insurance, short term disability insurance, long term disability insurance, critical illness insurance, accident insurance, dental insurance, vision care insurance, flexible disability insurance, and a package of insurance options.

4. The system of claim 1, wherein the transmitted information includes at least one of available plan options and insurance rates.

5. The system of claim 1, wherein the transmitted information includes at least one of: an employer name, a logo, display preferences, a layout template, contact information, live contact support information, enrollment period information, scheduled events, and question and answer information.

6. The system of claim 1, wherein the transmitted information is further customized based on information about the employer.

7. The system of claim 6, wherein the information about the employer includes at least one of a number of employees, a location, and a type of work performed.

8. The system of claim 1, wherein the transmitted information is further based on information about the employee.

9. The system of claim 8, wherein the information about the employee includes at least one of age, sex, occupation, address, marital status, and a number of children.

10. The system of claim 8, wherein execution of the program instructions further cause the processor to:
assign the employee into a category, wherein the transmitted information is further customized based on the assigned category.

11. The system of claim 1, wherein the transmitted information is further customized based on information received from a third party service.

12. The system of claim 11, wherein the information received from the third party service is associated with at least one of social media network data, a credit score, an age, a sex, an occupation, and an address.

13. The system of claim 1, wherein the transmitted information is to facilitate a display of benefit rate information to the employee.

14. The system of claim 13, wherein the benefit rate information is associated with at least one of a predicted benefit rate and an actual benefit rate.

15. The system of claim 13, wherein execution of the program instructions further cause the processor to:
automatically translate benefit rate information into an equivalent consumer product or service.

16. The system of claim 15, wherein the equivalent consumer product or service is selected based at least in part on information about the employee.

17. The system of claim 1, wherein execution of the program instructions further cause the processor to:
graphically display benefit rate information as compared to other costs associated with the employee.

18. The system of claim 1, wherein the transmitted information is to facilitate a display of testimonial information to the employee, wherein the testimonial information is selected based at least in part on information about the employee.

19. The system of claim 1, wherein execution of the program instructions further cause the processor to:
begin a process of enrolling the employee in a selected voluntary employee benefit plan, including automatically populating fields in an enrollment form.

20. The system of claim 1, wherein execution of the program instructions further cause the processor to:
support access, by the employee, to information about an insurance claim made in connection with at least one voluntary employee benefit plan.

21. The system of claim 1, wherein execution of the program instructions further cause the processor to:
support at least one of a rating and review employee application, an incentive program, a loyalty reward, and a redeemable code.

22. The system of claim 1, wherein the request from the employee is received from at least one of a remote mobile device, a wireless telephone, a smartphone a personal computer, and a television.

23. The system of claim 1, wherein the customization performed by at least one of an insurance provider and a third party administrator.

24. A computer-implemented method associated with a plurality of employers, each employer being associated with a set of voluntary employee benefit plans, comprising:
receiving, from a remote employee device via a communication network, a request to access a voluntary employee benefit portal;
automatically determining, buy a portal management platform, an employer associated with the employee;
automatically accessing information about the set of voluntary employee benefit plans associated with determined employer;
assigning the employee into a category; and
transmitting, to the remote employee device, information associated with the voluntary employee benefit portal, wherein the transmitted information is customized based at least in part on the assigned category and the information about the set of voluntary employee benefit plans associated with the determined employer.

25. The method of claim 24, wherein the employee is assigned to the category based on at least one of age, sex, occupation, address, marital status, and a number of children.

26. The method of claim 24, wherein the transmitted information is to facilitate a display of benefit rate information to the employee and further comprising:
automatically translating the benefit rate information into an equivalent consumer product or service.

27. A non-transitory, computer-readable medium storing program instructions adapted to be executed by a computer processor to perform a method associated with a plurality of employers, each employer being associated with a set of voluntary employee benefit plans, said method comprising:
receiving, from a remote employee device via a communication network, a request to access a voluntary employee benefit portal;
automatically determining, buy a portal management platform, an employer associated with the employee;
automatically accessing information about the set of voluntary employee benefit plans associated with determined employer; and
transmitting, to the remote employee device, information associated with the voluntary employee benefit portal, wherein the transmitted information includes at least one of available plan options and insurance rates that have been customized based at least in part on the information about the set of voluntary employee benefit plans associated with the determined employer.

28. The medium of claim 27, wherein the determination of the employer is based on at least one of an employer identifier, an employee identifier, information provided by the employee, and information provided by the employer.

29. The medium of claim 27, wherein at least one voluntary employee benefit plan is associated with at least one of term life insurance, short term disability insurance, long term disability insurance, critical illness insurance, accident insurance, dental insurance, vision care insurance, flexible disability insurance, and a package of insurance options.

30. The medium of claim 27, wherein the transmitted information is to facilitate a display of benefit rate information to the employee and execution of the program instructions further result in the processor:
automatically translating the benefit rate information into an equivalent consumer product or service.
